(19) United States
(12) Patent Application Publication
(10) Pub. No.: US 2015/0262444 A1
(43) Pub. Date: Sep. 17, 2015

(54) METHOD AND APPARATUS FOR PROCESSING USER VOTES FOR LOCATIONS

(71) Applicant: Soul Purpose Limited, Coventry (GB)

(72) Inventors: Paul Gilligan, Warwickshire (GB); James Clyne, Southam (GB)

(21) Appl. No.: 14/636,862

(22) Filed: Mar. 3, 2015

(30) Foreign Application Priority Data
Mar. 17, 2014 (GB) GB 1404777.3

(51) Int. Cl. G07C 13/00

(52) U.S. Cl. CPC G07C 13/00

(57) ABSTRACT

A computer apparatus and method for determining score data for a location, comprising receiving a vote input by a user on a visit to a location from a user's mobile device, the vote input representing a vote for the location and including an identifier for the user's mobile device or the user and information identifying the location; retrieving from storage score data for the user and score data for the location, the score data for the user being a derivative of previous vote inputs for locations and the score data for the location being a derivative of previous vote inputs by users for the location; and determining score data for the visit dependent upon the score data for the user and the score data for the location; wherein the score data for the location is modified dependent upon the determined score data for the visit.

### PRIORITY APPLICATION

This application claims the benefit of priority under 35 U.S.C. §119 to United Kingdom Patent Application No. GB 1404777.3, filed on 17 Mar. 2014; which application is incorporated herein by reference in its entirety.

### FIELD OF THE INVENTION

The present invention relates to a method and apparatus for processing votes for locations by users who visit the locations.

### BACKGROUND INFORMATION

People like to be able to access information on locations they might wish to visit in order to assess other people's opinions on the locations before they consider visiting. Web sites such as Tripadvisor™ provide a medium for people to provide feedback and opinions on a range of locations and services. The limitation of such sites is that they require detailed data to be input by the people giving their opinions on places visited. In addition, people wishing to view the information are required to sift through a large amount of information. This information requirement acts as a deterrent to all but the most dedicated users.

### BRIEF DESCRIPTION OF THE DRAWINGS

FIG. 1 is a schematic diagram illustrating a system according to one embodiment;

FIG. 2 is a schematic diagram of a user's mobile device according to one embodiment;

FIG. 3 is a flow diagram illustrating the registration process according to one embodiment;

FIG. 4 is a flow diagram illustrating the process for token generation for use in authentication according to one embodiment;

FIG. 5 is a flow diagram illustrating the process for receiving and processing a vote to generate score data according to one embodiment;

FIG. 6 is a diagram illustrating the process for processing the score objects of the embodiment of FIG. 5 according to a first embodiment;

FIG. 7 is a diagram illustrating the graph data structure for the score data according to the first embodiment;

FIG. 8 is a diagram illustrating the process for processing the score objects of the embodiment of FIG. 5 according to a second embodiment;

FIG. 9 is a diagram illustrating the graph data structure for the score data according to the second embodiment;

FIG. 10 is a diagram illustrating a user interface on a user's mobile device according to one embodiment; and

FIG. 11 is a flow diagram illustrating the process for generating the user interface of FIG. 10.

### DETAILED DESCRIPTION

In the following detailed description, reference is made to the accompanying drawings that form a part hereof, and in which is shown by way of illustration specific embodiments in which the inventive subject matter may be practiced. These embodiments are described in sufficient detail to enable those skilled in the art to practice them, and it is to be understood that other embodiments may be utilized and that structural, logical, and electrical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims.

In the following embodiments, like components are labelled with like reference numerals.

The functions or algorithms described herein are implemented in hardware, software or a combination of software and hardware in one embodiment. The software comprises computer executable instructions stored on computer readable media such as memory or other type of storage devices. Further, described functions may correspond to modules, which may be software, hardware, firmware, or any combination thereof. Multiple functions are performed in one or more modules as desired, and the embodiments described are merely examples. The software is executed on a digital signal processor, ASIC, microprocessor, or other type of processor operating on a system, such as a personal computer, server, a router, or other device capable of processing data including network interconnection devices.

Some embodiments implement the functions in two or more specific interconnected hardware modules or devices with related control and data signals communicated between and through the modules, or as portions of an application-specific integrated circuit. Thus, the exemplary process flow is applicable to software, firmware, and hardware implementations.

A generalized embodiment provides for a method apparatus and system in which users can simply input a vote when they are at a location for the location, e.g. to indicate a feeling for the location such as they like it. The input is a simple binary input: they only select to make an input if they want to make a subjective indication about the location and want to share this fact with other users. The subjective indication is predefined by the system before the votes are input by the users. Hence, the input by the user is just a perception by the user of whether the location meets the subjective criterion, such as desirable or ‘cool’. The selection can comprise simply clicking on a button or icon on a user interface of a user's mobile device when at a location. The user's mobile device can determine the location using an in built positioning sensor e.g. GPS, or by triangulation or from the IP address of the device, and the user's mobile device can be preregistered with the service so it can be used as the unique identifier for the user to avoid the user being required to input any information to uniquely identify them e.g. they need not enter a username and password. Hence, the user does not have to input any data on the location.

Embodiments encompass determining a link between the user and the location that has a link score associated with it, which is determined from a score for the user and a score for the location. The link score is then used to modify the location score. It can also modify the users score. In one embodiment, a link with new data can be formed for each visit (visit data) and so a user can have multiple links of this form to the location i.e. multiple visit data. In an alternative embodiment, the link can be a single connection with connection data that is modified for subsequent visits to the location by the user.

Embodiments also provide for the use of the received votes from the users by entities associated with the locations. For example, the entities can request access to limited information on the votes, such as the number of votes for their location and other locations, the repeat visit figures for users, the scores for the visiting users, and the demographics of the users. The computer apparatus can also receive offer data from the entities indicative of offers they wish to make to users that visit their locations or users with high scores to entice them to visit their location. The computer apparatus can process the offer data and the score data to determine appropriate offers to transmit to the users. In such embodiments, the entities can be charged based on each vote made for their location, and/or on the basis of the data they wish to access.

In the embodiments, a vote is a deliberate user action that registers a user response to something at a location, their response being that in their view the object at the location has achieved a state. A ‘vote’ can mean any of:
i) a vote based on how judge something is judged. It may be judged to be fun, cool, interesting, educational, exciting, beautiful, dull, liked, or disliked for example,
ii) a vote based on how a person feels about something. The person may feel happy, silly, inspired, threatened, moved, or reckless for example, or
iii) a vote based on something measurable and a threshold being (or being judged to be) breached. A location may be busier than a reference location, an event at a location could be more expensive than a threshold price for example.

A vote for a location is a simple way for a user to give an opinion on a location. The opinion can be positive or negative e.g. like or dislike.

The something at a location can be a time related event, such as a concert or a static thing, such as a restaurant or scenery.

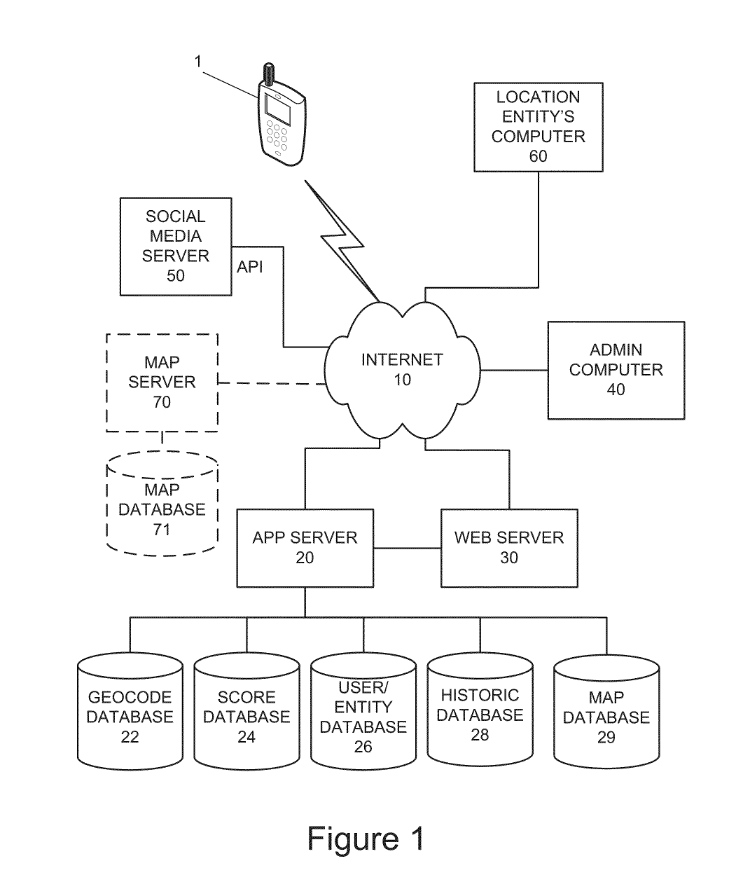

A specific embodiment will now be described with reference to FIG. 1, which is a schematic diagram of a system of one embodiment including a computer apparatus for providing the service (comprising the servers 20 and 30 and the databases 22 to 29) and a user's mobile device 1 to input votes to the services.

The user's mobile device is connected to the internet by any suitable network communication arrangement, such as a wired connection e.g. plugging the device into an Ethernet network at a location, or wireless connection e.g. Wi-Fi, Bluetooth or a cellular telecommunications connection using an internet protocol. Although only one user's mobile device 1 is shown, many users will use many such devices to access the service.

Computer apparatus for providing the service comprises a web server 30 for access to web pages by a web client application on the user's mobile device 1 for example. The web server 30 is connected to the internet over any suitable network connection, wired or wireless and can comprise a separate hardware server or server software implemented with an application server 20 also implemented as software on a hardware server. The application server 20 is also connected to the internet 10 over any suitable network connection, wired or wireless and is also connected to the web server 30. The application server 20 implements software module to implement the functionality described hereinafter. The application server 20 is connected to a number of databases, namely a geocode database 22 storing geocode and location data, a score database 25 storing score data (in one embodiment the score database 24 is a graph database), a user and location entity database 26 storing data on users and location entities including financial data for location entities related to payments for the service, a historic database 28 storing historic data recording the reception of votes from users for example, and a map database 29 storing map data for use in the generation of map output data to users and location entities with overlaid information on votes by users for locations. As an alternative to the computer apparatus having an internal map database, the computer apparatus can access a third party map server 70 with its associated map database 71 to obtain the required map data for the generation of map output data for users and location entities. The map server 70 can be accessed over the internet e.g. Google Maps.

Although this embodiment is described with reference to separate databases 22 to 29, the data used in the embodiments may be organized in any number of databases or just a single database.

A location entity's computer 60 is provided connected to the internet 10 to access the service, by accessing the web server 30 to access web pages by logging in. The location entity's computer 60 can implement a web browser to access the server and can comprise any suitable computer device to access the internet such as a laptop, smart phone, or tablet computer, and any public access computer could be used by the entity or more than one entity. Although only one location entity computer is shown, many such computers can be used by many entities. A location entity is an entity associated with a location. It can be an entity that owns the location, an entity that is located at the location, of an entity that has some interest in a location. Entities can include, merchants (e.g. shops, restaurants, bars) entertainment venues (e.g. cinemas, theatres, circus, sports venues), leisure facilities (e.g. beech, sports facilities), or a location e.g. a town for which the associated entity could be the town council, a nature reserve, a national park, or historic monument or building for example.

The location entity's computer 60 enables the location entity to receive and process payment requests for access to the service and to access data made available in the databases on the votes from the users and some data on the users such as demographic data.

An administrator's computer 40 is provided for use by an administrator of the system. The administrator's computer is connected to the internet 10 for access to the web server 30 for access to the databases 22 to 29 for administrative purposes.

The application server 20 is able to connect to a social media server 50 e.g. Facebook via an API to use information about users that has voted to identify related users using the social graph provided by the social media server 50. The retrieval of user relationship enables the application server to process the score data for users to generate a user interface for users to generate map data which includes data on votes made by related users within a region close to the location of the user. Thus, rather than just highlight locations that all users have voted form on a map, the server is able to restrict the votes rendered to the map to just the votes for related users as determined from the social graph data.

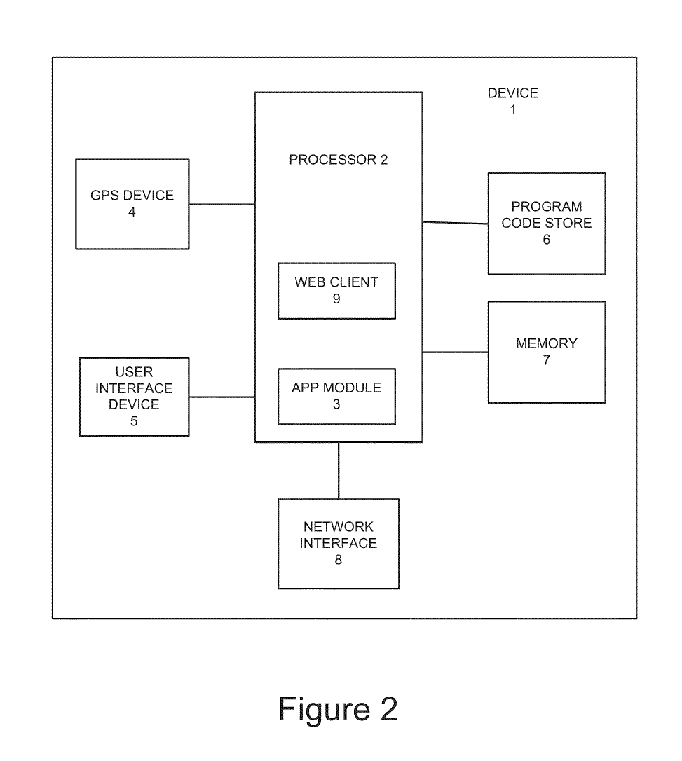

FIG. 2 is a schematic diagram of the user's mobile device according to one embodiment.

The user device comprises a processor 2 implementing software code in the form of a browser client 9 and an app module 3. A program code store 6 stores the program code for loading into and implementation by the processor 2. A working memory 7 is provided for use by the processor 2 and a network interface 8 is provided connected to the processor 2 for communication over the internet 10. The network interface 8 can comprise a wireless interface for communication wirelessly using an internet protocol e.g. communication using Wi-Fi, Bluetooth or a cellular telecommunication network. An integral positioning device in the form of a GPS device 4 is provided connected to the processor 2 to provide position information on the location of the device and hence the location of the user. A user interface 5 is provided connected to the processor 2 to enable a user to input a vote and to see displayed information such as a map showing the location of the user and the location and status of votes by other users. The user interface can comprise any form of display device in conjunction with any form of input device such as a keyboard, keypad or touch screen.

The processor 2 implements the web client 9 to enable the user to initially connect to the web server 30 to download the app code and to register any user data required for the service. The app module 3 is implemented by the processor after being downloaded and installed to provide the ability to input vote data and to view other users vote data on a display. The app module 3 communicates with the app server 20 over the internet 10 and can also receive other data such as offers for products or services provided by entities at locations or related to locations.

The operation of the apparatus described with reference to FIGS. 1 and 2 will now be described.

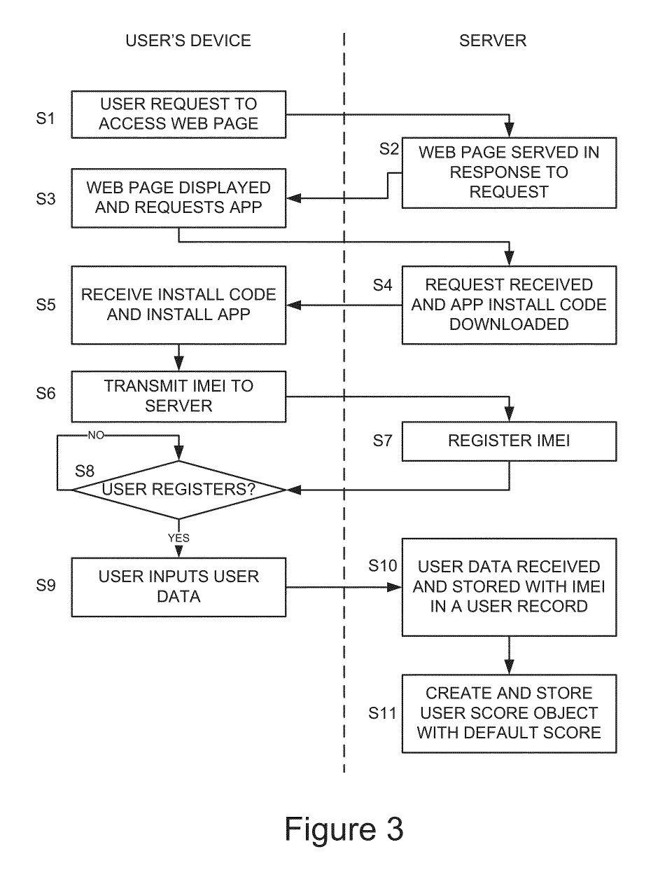

FIG. 3 is a flow diagram illustrating the process for registering a user for the service. In step S1a user uses the web client 9 to request access to a web page on the web server 30 to register to access the service. In step S2 the web server 30 responds with the requested web page, which is displayed at the user's device 1 and a request is generated for the downloading of the app (step S3). The web server 30 receives the request for the app and instructs the app server 20 to download the app installation code to the user's device 1 (step S4). The app installation code is received and installed at the user's device (step S5). The app module 3 then executes to identify the International Mobile Station Equipment Identity (IMEI) code for the user's device and transmits this to the app server 20 (step S6). The IMEI code is received at the app server 20 and is registered as a proxy for the identify of a user, since no personal data need be entered by the user which can uniquely identify them. The unique identity of the user is assumed by the unique identifier in the form of the IMEI provided by the user's device. Although the IMEI is used in this example for a mobile telephone, any code uniquely identifying the hardware could be used such as a Media Access Control address (MAC address).

In step S8, a user may be required to enter some anonymous demographic data such as age, sex, and nationality that can be used when processing votes and score data to provide useful information to location entities as will be described in more detail herein after. The data input by the user can be termed personal data since it is personal to them, but is does not comprise sensitive personal data which can be directly and uniquely attributed to them. The data is input by the user (step S9) and transmitted to the app server 20, where it is stored in a record for the user with the IMEI (step S10).

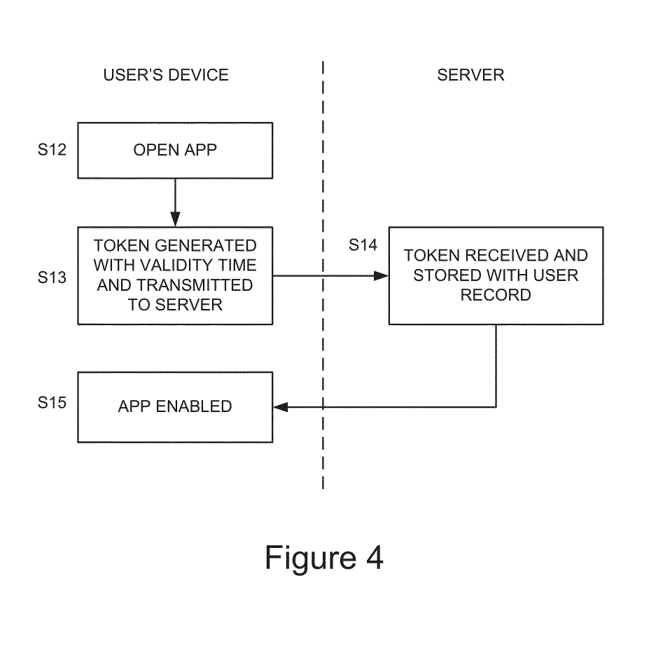

FIG. 4 is a flow diagram illustrating an initialization process that takes place before the app module 3 is enabled for the service.

In step S12 a user opens the app module 3 and the app module generates a token using the IMEI with a time stamp associated with it, which can be the generation time or the validity time i.e. termination time. The generated token is then transmitted to the server (step S13). The token is received at the app server 20 and stored with the user record (step S14). The app module 3 is now enabled (step S15).

As an alternative to transmission of the IMEI from the user's device 1, when the user's device 1 registers, the server can generate a unique token and transmit it back to the user's device, where it is stored. Thus both the user's device and the server store the same token for the unique identification of the user's device and hence the user. This token can be sent to the server with communications to the server to authenticate the user and the identify the user.

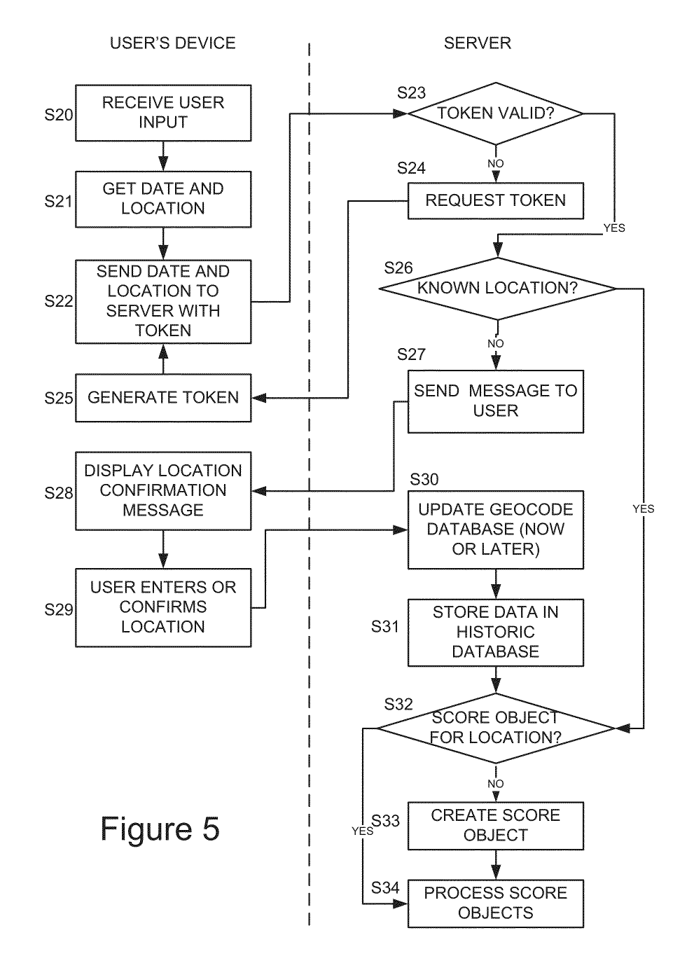

The process for inputting and processing votes will now be described with reference to FIG. 5.

When a user is at a location that they like or think is ‘cool’, the user selects to input a vote on their user's device 1 (step S20). The user selection simply requires the user to select a button or icon. It is a single action input. In response, the app module 3 in the user device 1 obtains location information from the GPS device 4 and determines the date and time from the user's device system date and time (step S21). The user is not required to enter any data such as location data in this embodiment since this is obtained automatically from the location detection capabilities of the user's device. However, in an alternative embodiment, a user may wish to, and be permitted to, select a location from a list, or on a map, or even enter it manually and select to vote. This can allow a user to vote after leaving a location and forgetting to vote while at the location or not being able to vote at the location (e.g. because no network connection was available at the location).

The date, time and location information is then sent with the token to the application server 20 (step S22). The token servers acts as to enable authentication of the data from the user's device. The token is then validated at the application server 20 (step S23) by checking it against known tokens for users and also checking if it has expired. If the token is not valid a request is sent back to the user's device 1 for a valid token (step S24). The token may no longer be valid for example because it has expired. The app module 3 in the user's device 1 hence generated a new token (step S22) and the date, time and location information is resent with the new token to the app server (step S22).

If the token is determined to be valid (step S23), the location information is compared to location information in the geocode database 22 to determine if the location is known (step S26). The comparison is performed by comparing the location information from the user's device, which is in this embodiment in the form of geo coordinates, with the geo coordinates in the database 22 to determine if the database holds a location record for that location. A location record will comprise data such as a location identifier, and geo coordinates. The location identifier will link to data on a location entity associated with the location in the user/entity database 26 and to location score data in the score database 24.

If the location is not known, a message is sent to the user's device 1 (step S27), which causes the app module to display a location confirmation message to the user (step S28). The user can then enter location information in step S29. In an alternative embodiment, prior to sending the message in step S27, the app server uses the location information to look-up known locations in the geocode database (i.e. locations with a location identifier) to identify known locations within a predetermined range or region of the unknown location. This list of close known locations can be sent within the message to the user's device (step S27), and in step S28 the list of close locations can be displayed to the user to enable them to select one if appropriate in step S29.

The entered or selected location information is sent to the application server 20 and in step S30 this is used to update the geocode database. If the user selected a location from the list, the coordinates for the location record are updated. If the user enters new location data, a new location record is generated with a new location identifier. This updating of the geocode database need not take place immediately i.e. at this point in the process.

In step S31 the input user data (vote input) is stored in the historic database 28 so as to keep an audit record of the transactions processed.

In step S32 the location identifier is used to look up in the score database 24 to see if there is a score data object for the location (step S32). If in step S26, the location information enables the application server 20 to identify a location record in the geocode database 22, the process jumps to step S32.

If there is no score data object for the location (step S32), score object data is created for the location with a default score e.g. 1 (step S33). If there is a score data object for the location (step S32), the process moves to step S34. In step S34 the score data objects for the location, the user and the visit by the user to the location (i.e. the link between the user and the location) are processed (step S34).

In the alternative embodiment in which the IMEI is not available from the user's device and the token is generated by the server and stored at the server and the user's device, steps S24 and S25 are not implemented. If the token is invalid (step S23) the server can fail the transaction.

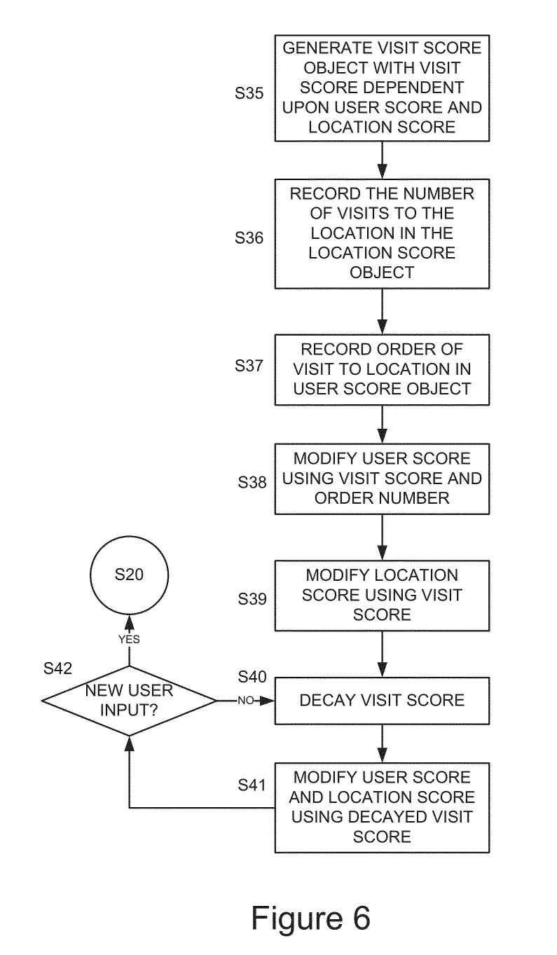

The determination and processing of the score data in steps S34 will now be described in detail with reference to FIGS. 6 to 9, which illustrate two alternative embodiments.

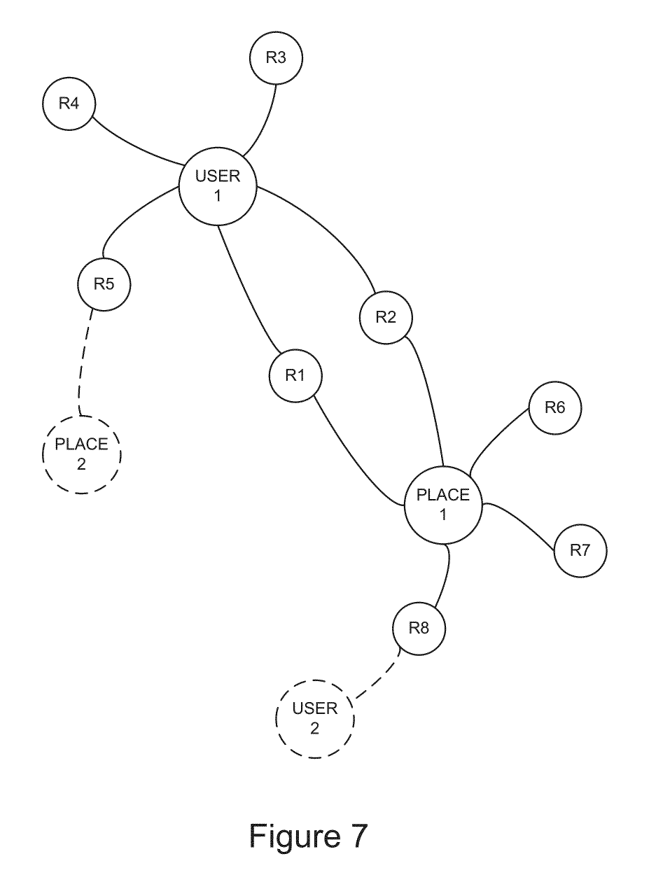

A first embodiment will be described with reference to FIGS. 6 and 7.

The data processing operates using three score data objects, with the following data structure:

Location Score Data Object
Location id
Number of visit by users to the locations (links) (can be equated to the number of votes)
Current score for the location

User Score Data Object
User id
Visit ids
Order number for each visit id
Current score

Visit (Link) Score Data Object
Visit id
User ids
Location ids
Current score
Decay rate
Original score

FIG. 7 illustrates a graph data structure for the score data objects. In the diagram, first user score data object User 1 is linked to visit score data objects R1, R2, R3, R4, and R5. A first location score object data Place 1 is linked to visit score data objects R1, R2, R6, R7, and R8. A second user score data object User 2 is illustrated linked to visits score data object R8 and a second location score data object Place 2 is illustrated linked to visit score data structure R5.

As can be seen from the data structure defined above and FIG. 7, a user score data object is uniquely identified by its identifier and has linked to it a number of visit score data objects identified by their visit identifiers. Similarly a location score data object is uniquely identified by its identifier and has linked to it a number of visit score data objects identified by their visit identifiers, which in this instance are only stored in the visit score data object. Both the user score data object and the location score data object include a current score for the object.

The user score data object also stores the identifiers for the visits and an order number for each visit. The order number comprises the order in which the user voted during a visit at the location relative to votes made by other users at the location. This is used to modify the user's score as will be described in more detail herein after.

The location score data structure also stores the number of visits or votes (links) by users. This is used in the calculation of a modification factor for the user score data object as will be described in more detail, herein after.

The visit (link) score data object has a unique identifier and stores identifiers to identify the links between the user score data objects and the location score data objects. The visit (link) score data object also stores the current score for the object and the original score for the object. These are different because the score decays according to a decay rate defined in the data object.

The scores for a user and a location are initially set to a default value e.g. 1 for new locations and new users.

As can be seen in FIG. 7, in this embodiment the data structure and process defines a new link score data object (a visit score data object) for each vote (visit) by a user to the same location. In FIG. 7 it can be seen that the user score data object User 1 has two visit score date objects R1 and R2 linking it to the location score object Place 1. In this way, each vote by a user during a visit is processed separately and decays separately, as will be described in more detail herein after. A score for a link between a location and a user in a visit (link) score data structure cannot be enhanced in this embodiment by later visits and votes for the location by the user.

The processing of the score data objects will now be described with reference to the flow diagram of FIG. 6. The processing can be performed using any suitable processing technique. However, the data structure is suited to graph processing in this embodiment, which enables the processing of supermassive data structures where large numbers of users and locations are involved. Such a processing technique is performed by the application server 20 and under this processing technique the location score data objects and the user score data objects are processed as vertices and the visit (link) score date objects are processed as directed edges (directed from the user to the location).

In step S35 of FIG. 6 as a result of a vote by a user for a location a visit score data object is generated with the visit score being dependent upon the user score and the location score. The visit score date object will be created with a new unique identifier and will include the identifiers of the linked or associated s and user score date objects. The current score for the visit is generated as a function of the scores of the location and the user e.g. a summation, a multiplication, or a weighted sum or multiplication. A decay rate for the visit score data object is stored. This decay rate can be fixed and the same for all visit score date objects or the decay rate can be set dependent upon a variable factor such as the score of the user.

The number of visits (votes) for the location is recorded in the location score date object (step S36) and the order of the visit (vote) for the location is stored in the user score data object (step S37). The order represents the order that the user voted for the location relative to other users. If the user is the first person to vote for the location their order number is 1. If they are second, their order number is 2 and so on.

Having calculated a score for the visit, the impact of the visit on the user's score and the location's score is then calculated. In step S38 the user's score is modified dependent upon the visit scores and the order number relative to the number of visits. The user's score is calculated as for example the sum (or other mathematical function) of all the visit scores linked to the user score data object. The result of this is then modified dependent upon the relative order of the user in placing their vote. The modification applied is related to the inverse of the order of the users vote in the list of votes placed for the location.

If the function applied to modify the user score data object is a multiplicative factor, the function Fᵢ for i=1 to x, where x is the number of visits stored in the location score data object and i is the order number stored in the user score data object, is given by:

$$\begin{matrix}When i = x , & {F}_{i} = 1 \\ else & {F}_{i} = \frac{x - i + 1}{x - i}\end{matrix}$$

If Fᵢ is an additive function, the equation is simplified to only require that 1 is added to all previous user scores for the location when a new visit score data object is created as a result of a new vote (visit).

In step S39 the location score is modified dependent upon the visit scores. The location score is calculated as for example the sum (or other mathematical function) of all the visit scores linked to the location score data object.

In step S40, the visit score is then decayed over time dependent upon the decay rate defined for the visit score data object. The decay is applied to reduce the effect of old votes (visits) on the score for locations and users. The decay can be applied in an exponential manner as a half-life with the half-life period being variable for different visit score data objects. The half-life period can for example be dependent upon and therefore set dependent upon the user's score at the time the visit score data object is created. This gives visits (votes) for users with high scores longer lasting effect compared to visits (votes) by users with lower scores.

As a result of the decay of the visit score, in step S41 the user's score and the location score are modified since their current score depends upon the current score for the visits linked to them. The process of decaying the visit score and modifying the user's score and the location score will continue repeatedly until a new user input is made (step S42). The rate of decay will depend upon a repeat processing cycle or clock. This can be fixed or variable.

In this embodiment, the number of visits by users is recorded in the location score data object. In an alternative embodiment, the number of visits is calculated when needed for the modification of the user's score by counting the number of visit score data objects linked to the location.

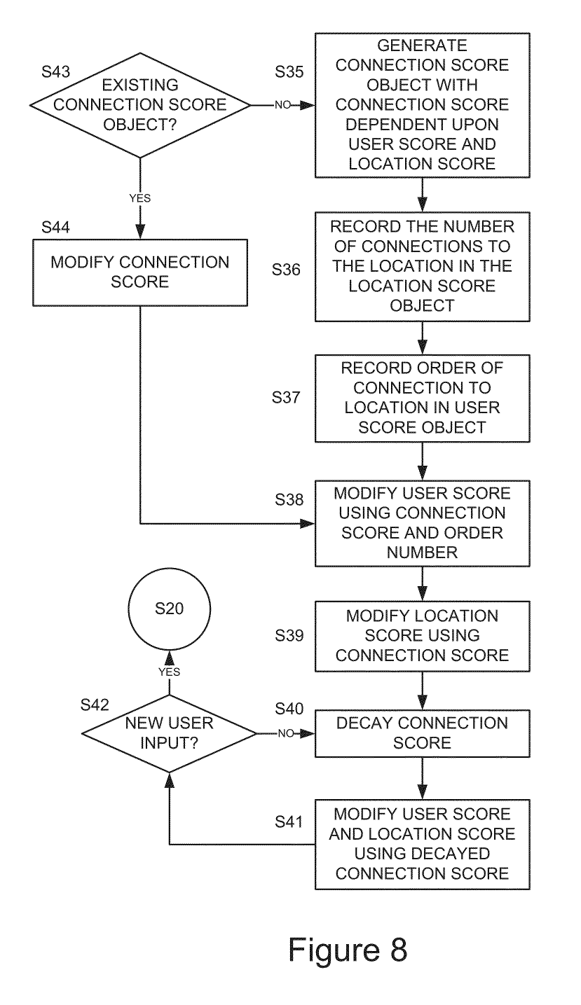

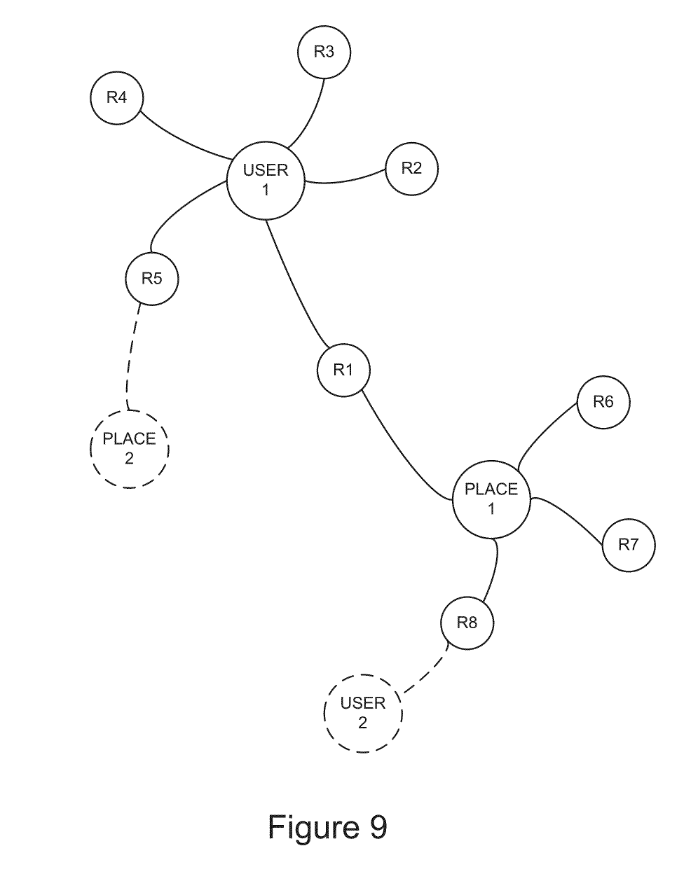

An alternative method of processing the score data objects will now be described with reference to FIGS. 8 and 9.

FIG. 9 illustrates a graph data structure for the score data objects. In the diagram, first user score data object User 1 is linked to link (connection) score data objects R1, R2, R3, R4, and R5. A first location score object data Place 1 is linked to connection score data objects R1, R6, R7, and R8. A second user score data object User 2 is illustrated linked to connection score data object R8 and a second location score data object Place 2 is illustrated linked to connection score data structure R5. This data structure differs from that of FIG. 7 in that there is only one link score date structure between a user score date structure and a location score data structure. This is a connection score data structure and it is created for a first visit (vote) by a user for a location and updated for later visits (votes) by the user for the location.

The processing of the score data objects will now be described with reference to the flow diagram of FIG. 8. The steps of the process that are the same as those of FIG. 6 are denoted by the same references.

In step S43 the process determines whether there is an existing connection score data object. If there is not, the process proceeds as described with reference to FIG. 6 from steps S35 to step S42. If there is already a connection score data object stored for a previous visit (vote) by the user for the location, the connection score is modified in a positive manner in step S44 e.g. multiplicatively or additively. In this way, if the connection score has been decaying over time, a revisit of a location by the user will restore the connection score.

The process then proceeds to steps S38 and then S39 where the user score and the location score linked to the connection score are modified in a manner described with reference to the previous embodiment. In this embodiment, the order number for a connection is not modified for revisits by the user. If the user initially visited a location after 2 people had visited and voted (i.e. their order number is 3), this is not changed.

The embodiments described herein above generate score data for locations and score data for users, which dynamically changes over time and as a result of votes placed for locations by the users.

Embodiments will now be described, in which the score data for the users and the location is made available to users and entities associated with locations.

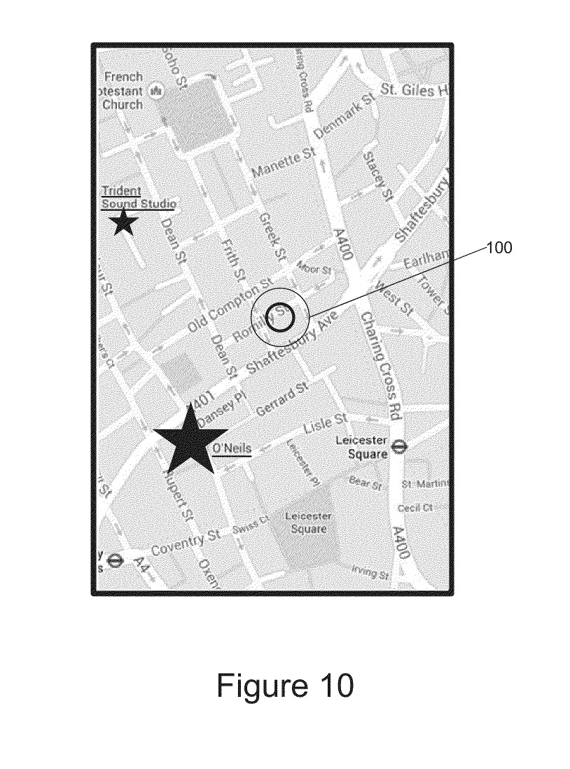

FIG. 10 illustrates a display on a user interface of a user's device 1. A map is displayed of the region in which the user is located, centred on the location of the user. At the centre of the display, a locator 100 indicates their current location to the user. In the region around the location of the user, icons or indicators indicate to the user locations that the user or other users have voted for. The indicators or icons can indicate to the user the number of votes by users by for example having a size which is proportional to the number of votes. Alternatively the number of voted could be indicated with a colour ranging from green to red, or by the number of the indicators or icons displayed. This information is presented to the user to inform them of locations in their region which other users liked or thought were ‘cool’. The user is therefore informed on what the community of users liked in the region.

In order to place a vote for the current location, the user can simply touch the screen on the locator 100 or press a key on a keyboard provided with the user interface in association with the display.

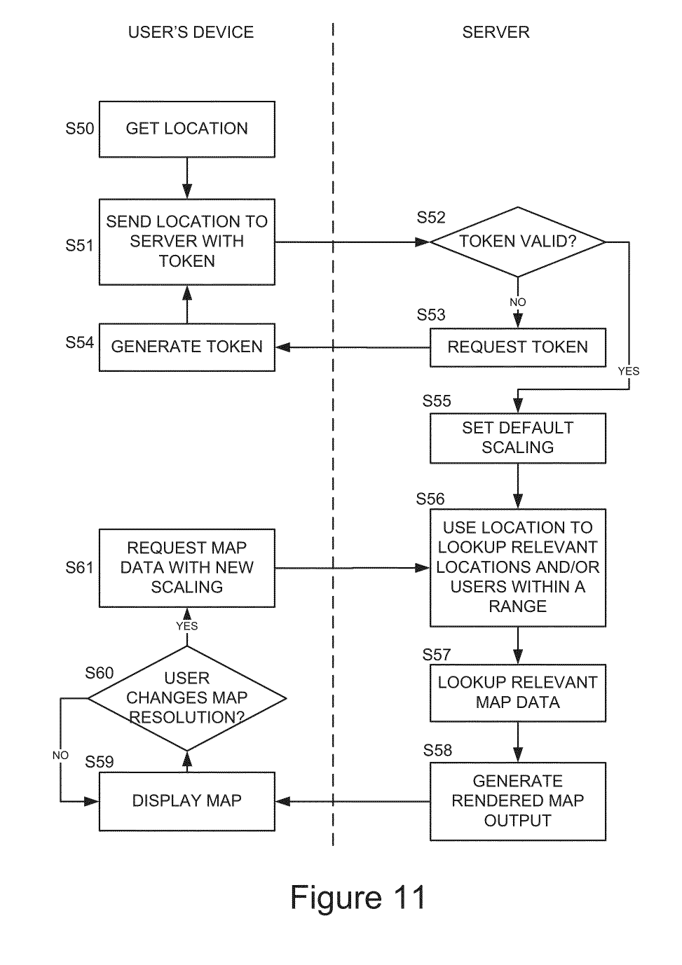

The process for generating the display on the user's device 1 will now be described with reference to the flow diagram of FIG. 11.

In step S50 the GPS device 4 of the user's device 1 determines the location of the user and in step S51 the location information is sent to the application server 20 along with the token for authentication. The application server 20 authenticates the token (steps S52) and if it is not authenticated the application server 20 requests a replacement token from the user's device 1 (step S53). The reason for the failure to authenticate the token might be that the token has expired. Therefore in step S54 the app module 3 in the user's device 1 generates a new token, which is sent with the location information to the application server 20 (step S51).

When the token is authenticated (step S52), an initial map scaling is set in step S55 and in step S56 the location information is used to lookup relevant locations and/or users within a range of the location of the user. The geocode data from the user's device can be used to look up location identifiers in the geocode database 22. The location identifiers can then be used to look up associated scores and users in the scores database 24 and the user/entity database 26. The relevant map data for the location and the region using the initial scaling can be looked up in the map database 29 or 71 (step S57) and map output data can be generated in step S58 for transmission to the user's device 1 for the rendering of the data for display (step S59). The displayed map can be manipulated to zoom in or out (step S60) and if a resolution change is made by the user, a request for new map data with a new scaling is made to the application server 20 in step S61. The application reprocesses the location data with a new range due to the change in scaling in step S56, new map data is looked up (step S57) and new map output data is generated (step S58) for rendering on the display of the user's device 1 (step S59).

In the above process, relevant users can be determined from data obtained from each user from a social network service, such as Facebook. The social network can provide a social graph for a user to provide information on ‘friends’. This information can be used when determining which users to display as being close to the user. The information on the location of the users can be obtained as a direct feed from the user's devices i.e. the users are tracked, or it could be based on the user's last vote location.

The use of the data by the entities associated with the locations will now be described.

The entities can subscribe to the service, whereby information they submit can be associated with the location. The information can be stored in the user/entity database 26 and can be displayed to the user on the user display when the map data is displayed. The entity can be charged for the service on a basis of a pay per vote and/or pay for access to data. The data available to the entity on the users is limited since the users are not required to enter personal data that allows them to be uniquely identified. The entity can review the data to identify users that return to the location so they can analyze repeat business.

The application server 20 can transmit payment request periodically to the location entity's computer 60, which can respond by authorizing payment. The record of the transactions can be recorded in the user/entity database 26 and this data can be used by the application server 20 to control access to the data by the entities.

Entities can thus access information to show where votes have been placed and these can include demographic information on the users. The votes can be not just for their location but also for other locations such as their competitors. This gives the entity useful competitive information. The historic database 28 can also store historic scores for locations and users to enable the entities to see how the scores have changed. This historic score information can also be made available to users.

The entity information submitted by the entity can include offer data for offers for their services or products. The entity can subscribe to a service offered by the apparatus in which the vote data input by the users is processed by the application server 20 to identify appropriate offers to be sent to the users. For example, a user may have visited a location and voted for it and the entity associated with the location wishes to encourage the user to return with an offer for a lower price for goods or services on the next visit. In another example, the a pattern of data may identify that a user visits a certain type of location often and an offer may be made on behalf of an entity to the user based on this information.

A user may register to subscribe to the offers service and may be willing to input more personal data in return for the offers. In turn, the additional personal data enables the application server to perform more sophisticated processing to better target offers to the user.

In this process for providing the user with offers, no unwarranted contact is made to the users by the entities. The users are isolated from the entities by the service. Contact is only made with users through the servicer of the computer apparatus. No contact information or personal information is shared with the entity, unless the user explicitly wishes this to occur e.g. the user enters personal data and permits it to be shared in return for higher value offers.

The following is a description of some generalized embodiments. Any embodiment can be used in combination with any other embodiment.

One aspect provides a computer implemented method of determining score data for a location, the method comprising receiving a vote input by a user on a visit to a location from a user's mobile device, the vote input representing a vote for the location and including an identifier for the user's mobile device or the user and information identifying the location; retrieving from storage score data for the user and score data for the location, the score data for the user being a derivative of previous vote inputs for locations and the score data for the location being a derivative of previous vote inputs by users for the location; and determining score data for the visit dependent upon the score data for the user and the score data for the location; wherein the score data for the location is modified dependent upon the determined score data for the visit.

In one embodiment, the score data for the user is modified dependent upon the determined score data for the visit.

In one embodiment, the method includes decaying the score data for the visit over time, wherein the score data for the location is modified dependent upon the decayed score data for the visit.

In one embodiment, the method includes decaying the score data for the visit over time, wherein the score data for the location is modified dependent upon the decayed score data for the visit, and the score data for the user is modified dependent upon the decayed score data for the visit.

In one embodiment, the method includes receiving a plurality of vote inputs by a plurality of users on a plurality of visits to the location, wherein the score data is determined for each visit dependent upon the score data for the user and the score data for the location, an order in which each visit occurs is recorded, the score data for each visit is modified dependent upon the order, and the score data for the location is modified dependent upon the determined score data for the visits.

In one embodiment, the score data for each visit is modified by a factor dependent upon the inverse of the order.

In one embodiment, the identifier for the user's mobile device or the user comprises a unique identifier for the user's mobile device.

In one embodiment, no personal information to uniquely identify the user is received.

In one embodiment, the information identifying the location comprises location coordinates, location data on known locations is stored comprising location coordinates and descriptive information, and the method includes using the location coordinates to look up the stored location data.

In one embodiment, if the location coordinates do not match location coordinates in the stored location data, the method includes generating data on possible locations from the location data, outputting the data to the user's mobile device, receiving a user selection of a location, and using the user selected location to retrieve the score data for the location.

In one embodiment, if the location coordinates do not match location coordinate in the stored location data, the method includes outputting the a request for location information to the user's mobile device, receiving a user input location information, storing the user input information in the storage, and setting the score data for the location in the storage to an initial value.

In one embodiment, the information identifying the location comprises geographic coordinates or geocode determined by the user's mobile device automatically.

In one embodiment, the vote input is received as a result of a user selection of a vote button or icon.

In one embodiment, the receiving, retrieving and determining are repeated for vote inputs by a plurality of users for visits to a plurality of locations, wherein the score data for each location is modified dependent upon the determined score data for the visits by the users to the location.

In one embodiment, the score data for each user is modified dependent upon the determined score data for the visits to the locations by the user.

Another aspect provides a computer apparatus for determining score data for a location, the apparatus comprising a program memory storing program code; and a processor for implementing the program code stored in the program memory; wherein the program code comprises code for controlling the processor to receive a vote input by a user on a visit to a location from a user's mobile device, the vote input representing a vote for the location and including an identifier for the user's mobile device or the user and information identifying the location; code for controlling the processor to retrieve from storage score data for the user and score data for the location, the score data for the user being a derivative of previous vote inputs for locations and the score data for the location being a derivative of previous vote inputs by users for the location; and code for controlling the processor to determine score data for the visit dependent upon the score data for the user and the score data for the location; wherein the code for controlling the processor comprises code for controlling the processor to modify the score data for the location dependent upon the determined score data for the visit.

In one embodiment, the code for controlling the processor comprises code for controlling the processor to modify the score data for the user dependent upon the determined score data for the visit.

In one embodiment the code includes the code for controlling the processor to decay the score data for the visit over time, wherein the code for controlling the processor comprises code for controlling the processor to modify the score data for the location dependent upon the decayed score data for the visit.

In one embodiment the code includes code for controlling the processor to decay the score data for the visit over time, wherein the code for controlling the processor comprises code for controlling the processor to modify the score data for the location dependent upon the decayed score data for the visit, and the code for controlling the processor comprises code for controlling the processor to modify the score data for the user dependent upon the decayed score data for the visit.

In one embodiment the code includes code for controlling the processor to receive a plurality of vote inputs by a plurality of users on a plurality of visits to the location, wherein the code for controlling the processor comprises code for controlling the processor to determine the score data for each visit dependent upon the score data for the user and the score data for the location, the code for controlling the processor comprises code for controlling the processor to record an order in which each visit occurs, the code for controlling the processor comprises code for controlling the processor to modify the score data for each visit dependent upon the order, and the code for controlling the processor comprises code for controlling the processor to modify the score data for the location dependent upon the determined score data for the visits.

In one embodiment, the code for controlling the processor comprises code for controlling the processor to modify the score data for each visit by a factor dependent upon the inverse of the order.

In one embodiment, the identifier for the user's mobile device or the user comprises a unique identifier for the user's mobile device.

In one embodiment, no personal information to uniquely identify the user is received.

In one embodiment, the information identifying the location comprises location coordinates, the code for controlling the processor comprises code for controlling the processor to store location data on known locations comprising location coordinates and descriptive information, and the code for controlling the processor comprises code for controlling the processor to use the location coordinates to look up the stored location data.

In one embodiment, the code for controlling the processor comprises code for controlling the processor to, if the location coordinates do not match location coordinate in the stored location data, generate data on possible locations from the location data, output the data to the user's mobile device, receive a user selection of a location, and use the user selected location to retrieve the score data for the location.

In one embodiment, the code for controlling the processor comprises code for controlling the processor to, if the location coordinates do not match location coordinates in the stored location data, output the a request for location information to the user's mobile device, receive a user input location information, store the user input information in the storage, and set the score data for the location in the storage to an initial value.

In one embodiment, the information identifying the location comprises geographic coordinates or geocode determined by the user's mobile device automatically.

In one embodiment, the code for controlling the processor comprises code for controlling the processor to receive the vote input as a result of a user selection of a vote button or icon.

In one embodiment, the code for controlling the processor comprises code for controlling the processor to repeat the receiving, retrieving and determining for vote inputs by a plurality of users for visits to a plurality of locations, and the code for controlling the processor comprises code for controlling the processor to modify the score data for each location dependent upon the determined score data for the visits by the users to the location.

In one embodiment, the code for controlling the processor comprises code for controlling the processor to modify the score data for each user dependent upon the determined score data for the visits to the locations by the user.

Another aspect provides a computer implemented method of processing vote inputs for a location, the method comprising receiving a vote input by a user on a visit to a location from a user's mobile device, the vote input representing a vote for the location and including an identifier for the user's mobile device or the user and information identifying the location; and determining score data for the user, score data for the location, and score data for the visit by the user to the location using a graph processing method accessing a graph database storing the score data for the user, score data for the location, and score data for visits by users to the location; the graph processing method dynamically calculating score data for the visit dependent upon the stored score data for the user and the stored score data for the location, updated score data for the user using stored score data for the user and calculated score data for the visit, and updated score data for the location using stored score data for the location and calculated score data for the visit.

In one embodiment, vote inputs from a plurality of users for a plurality of locations are received; score data for the users, score data for the locations, and score data for the visits by the users to the locations are dynamically determined using the graph processing method accessing the graph database storing the score data for the users, score data for the locations, and score data for visits by users to the locations; and the graph processing method dynamically calculates score data for the visits dependent upon the stored score data for the respective users and the stored score data for the respective locations, updated score data for the users using stored score data for the respective users and calculated score data for the respective visits, and updated score data for the locations using stored score data for the respective locations and calculated score data for the respective visits.

Another aspect provides a computer apparatus for processing vote inputs for a location, the apparatus comprising a graph database storing score data for users, score data for locations, and score data for visits by users to the locations; a network interface for receiving a vote input by a user on a visit to a location from a user's mobile device, the vote input representing a vote for the location and including an identifier for the user's mobile device or the user and information identifying the location; and a graph processor for determining score data for the user, score data for the location, and score data for the visit by the user to the location using a graph processing method accessing the graph database; the graph processor being programmed to dynamically calculate score data for the visit dependent upon the stored score data for the user and the stored score data for the location, updated score data for the user using stored score data for the user and calculated score data for the visit, and updated score data for the location using stored score data for the location and calculated score data for the visit.

In one embodiment, the network interface is arranged to receive vote inputs from a plurality of users for a plurality of locations; and the graph processor is programmed to dynamically determine score data for the users, score data for the locations, and score data for the visits by the users to the locations by calculating score data for the visits dependent upon the stored score data for the respective users and the stored score data for the respective locations, updated score data for the users using stored score data for the respective users and calculated score data for the respective visits, and updated score data for the locations using stored score data for the respective locations and calculated score data for the respective visits.

Another aspect provides a computer apparatus for determining score data for a location, the apparatus comprising means for receiving a vote input by a user on a visit to a location from a user's mobile device, the vote input representing a vote for the location and including an identifier for the user's mobile device or the user and information identifying the location; means for retrieving from storage score data for the user and score data for the location, the stored score data for the user being a derivative of previous vote inputs for locations and the stored score data for the location being a derivative of previous vote inputs by users for the location; means for determining score data for the visit dependent upon the score data for the user and the score data for the location; and means for modifying the score data for the location dependent upon the determined score data for the visit.

Another aspect provides a computer apparatus for processing vote inputs for a location, the apparatus comprising means for receiving a vote input by a user on a visit to a location from a user's mobile device, the vote input representing a vote for the location and including an identifier for the user's mobile device or the user and information identifying the location; and means for determining score data for the user, score data for the location, and score data for the visit by the user to the location using a graph processing means storing the score data for the user, score data for the location, and score data for visits by users to the location; the graph processing means being adapted to dynamically calculate score data for the visit dependent upon the stored score data for the user and the stored score data for the location, updated score data for the user using stored score data for the user and calculated score data for the visit, and updated score data for the location using stored score data for the location and calculated score data for the visit.

Another aspect provides a method of providing information to users on the popularity of locations, the method comprising receiving information identifying the location of the user from a user's mobile device; using the location information to identify score data for locations within a range in a data store, the score data for the locations being a derivative of score data for users visiting the locations; and outputting data for the generation a user interface for the user to display an indication of the score data for the locations on a map showing the locations within the range.

Another aspect provides a computer apparatus for providing information to users on the popularity of locations, the apparatus comprising a program memory storing program code; and a processor for implementing the program code stored in the program memory; wherein the program code comprises code for controlling the processor to receive information identifying the location of the user from a user's mobile device; code for controlling the processor to use the location information to identify score data for locations within a range in a data store, the score data for the locations being a derivative of score data for users visiting the locations; and code for controlling the processor to output data for the generation a user interface for the user to display an indication of the score data for the locations on a map showing the locations within the range.

Another aspect provides a mobile device for use by a user to enter a vote for a location, the device comprising a location detector for detecting the location of the user; a network interface for communicating the location over a network and for receiving map data; a display to display a map of a region including the location of the user and an indication of the location of the user using the map data; and a user input device to receive a user selection to vote for the location; wherein the network interface is adapted to transmit an indication of the vote, and information identifying the location and the user.

In one embodiment, the network interface is adapted to receive map data including score data derived from votes from users for locations in the region, and the display is adapted to display the map with indicators indicative of the score data for the locations at the locations.

In one embodiment, the user input device is adapted to receive the user selection as a single action selection of a button or an icon.

Another aspect provides a method of entering a user vote for a location, the method comprising detecting the location of the user; communicating the location over a network and receiving map data; displaying a map of a region including the location of the user and an indication of the location of the user using the map data; receiving a user selection to vote for the location; and transmitting an indication of the vote and information identifying the location and the user.

In one embodiment, the map data includes score data derived from votes from users for locations in the region, and the map is displayed with indicators indicative of the score data for the locations at the locations.

In one embodiment, the user selection is received as a single action selection of a button or an icon.

Another aspect provides a computer implemented method comprising receiving personal data for users using a network interface and storing the personal data in a storage device; receiving location data for locations using a network interface and storing the location data in the storage device, the location data including data identifying an entity associated with each location; receiving vote data from users at locations using mobile devices using the network interface; processing the vote data for the locations to determine a number of votes for each location using a processor and storing the processed vote data in the storage device; calculating payment required by each entity dependent upon the number of votes for the location associated with the entity using the processor; transmitting payment requests to the entities dependence upon the calculated payment required using the network interface; and permitting access to data in the storage device by entities associated with the respective locations, using the network interface, when payment is received from the respective entities in response to the transmitted payment requests.

Another aspect provides computer apparatus comprising a network interface to receive personal data for users; and a storage device to store the personal data; wherein the network interface is adapted to receive location data for locations and to store the location data in the storage device, the location data including data identifying an entity associated with each location; and to receive vote data from users at locations using mobile devices; the apparatus including a processor to process the vote data for the locations to determine a number of votes for each location, to store the processed vote data in the storage device, and to calculate payment required by each entity dependent upon the number of votes for the location associated with the entity; wherein the network interface is adapted to transmit payment requests to the entities dependent upon the calculated payment required using the network interface, and to permit access to data in the storage device by entities associated with the respective locations, when payment is received from the respective entities in response to the transmitted payment requests.

Another aspect provides a computer implemented method of determining score data for a location, the method comprising receiving a vote input by a user for a location from a user's mobile device, the vote input representing a vote for the location and including an identifier for the user's mobile device or the user and information identifying the location; retrieving from storage score data for the user and score data for the location, the score data for the user being a derivative of previous vote inputs for locations and the score data for the location being a derivative of previous vote inputs by users for the location; and determining score data for a connection between the user and the location dependent upon the score data for the user and the score data for the location; wherein the score data for the location is modified dependent upon the determined score data for the connection between the user and the location.

In one embodiment, the score data for the user is modified dependent upon the determined score data for the connection between the user and the location.

In one embodiment the method includes decaying the score data for the connection between the user and the location over time, wherein the score data for the location is modified dependent upon the decayed score data for the connection between the user and the location.

In one embodiment the method includes decaying the score data for the connection between the user and the location over time, wherein the score data for the location is modified dependent upon the decayed score data for the connection between the user and the location, and the score data for the user is modified dependent upon the decayed score data for the connection between the user and the location.

In one embodiment the method includes receiving a plurality of vote inputs by a plurality of users each having a connection with a respective location, wherein the score data is determined for each connection between a user and a location dependent upon the score data for the user and the score data for the location, an order in which each connection is made is recorded, the score data for the connection between the user and the location is modified dependent upon the order, and the score data for the location is modified dependent upon the determined score data for the connection between the user and the location.

Another aspect provides a computer apparatus for determining score data for a location, the apparatus comprising a program memory storing program code; and a processor for implementing the program code stored in the program memory; wherein the program code comprises code for controlling the processor to receive a vote input by a user for a location from a user's mobile device, the vote input representing a vote for the location and including an identifier for the user's mobile device or the user and information identifying the location; code for controlling the processor to retrieve from storage score data for the user and score data for the location, the score data for the user being a derivative of previous vote inputs for locations and the score data for the location being a derivative of previous vote inputs by users for the location; and code for controlling the processor to determine score data for a connection between the user and the location dependent upon the score data for the user and the score data for the location; wherein the code for controlling the processor comprises code for controlling the processor to modify the score data for the location dependent upon the determined score data for the connection between the user and the location.

In one embodiment, the code for controlling the processor comprises code for controlling the processor to modify score data for the user dependent upon the determined score data for the connection between the user and the location.

In one embodiment the code includes code for controlling the processor to decay the score data for the connection between the user and the location over time, wherein the code for controlling the processor comprises code for controlling the processor to modify the score data for the location dependent upon the decayed score data for the connection between the user and the location.

In one embodiment the code includes code for controlling the processor to decay the score data for the connection between the user and the location over time, wherein the code for controlling the processor comprises code for controlling the processor to modify the score data for the location dependent upon the decayed score data for the connection between the user and the location, and the code for controlling the processor comprises code for controlling the processor to modify the score data for the user dependent upon the decayed score data for the connection between the user and the location.

In one embodiment the code includes code for controlling the processor to receiving a plurality of vote inputs by a plurality of users each having a connection with a respective location, wherein the code for controlling the processor comprises code for controlling the processor to determine the score data for each connection between a user and a location dependent upon the score data for the user and the score data for the location, an order in which each connection is made is recorded, the code for controlling the processor comprises code for controlling the processor to modify the score data for the connection between the user and the location dependent upon the order, and the code for controlling the processor comprises code for controlling the processor to modify the score data for the location dependent upon the determined score data for the connection between the user and the location.

Another aspect provides a computer implemented method comprising receiving location data for locations using a network interface and storing the location data in the storage device, the location data including data identifying an entity associated with each location and offer data; receiving vote data from users at locations using mobile devices using the network interface; processing the vote data for the locations and the offer data to determine offers to be sent to the users using a processor; and transmitting the offers to the users using the network interface.

Another aspect provides computer apparatus comprising a program memory storing program code; and a processor for implementing the program code stored in the program memory; wherein the program code comprises code for controlling the processor to receive location data for locations and storing the location data, the location data including data identifying an entity associated with each location and offer data; code for controlling the processor to receive vote data from users at locations using mobile devices; code for controlling the processor to process the vote data for the locations and the offer data to determine offers to be sent to the users; and code for controlling the processor to transmit the offers to the users.

Another aspect provides a carrier medium such as a non-transient storage medium storing computer code for controlling a computer to carry out the method, or a transient medium carrying computer readable code for controlling a computer to carry out the method. Embodiments can be implemented in programmable digital logic that implements computer code. The code can be supplied to the programmable logic, such as a processor or microprocessor, on a carrier medium. One such form of carrier medium is a transient medium i.e. a signal such as an electrical, electromagnetic, acoustic, magnetic, or optical signal. Another form of carrier medium is a non-transitory medium that carries or stores the code, such as a solid-state memory, magnetic media (hard disk drive), or optical media (Compact disc (CD) or digital versatile disc (DVD)).

It will be readily understood to those skilled in the art that various other changes in the details, material, and arrangements of the parts and method stages which have been described and illustrated in order to explain the nature of the inventive subject matter may be made without departing from the principles and scope of the inventive subject matter as expressed in the subjoined claims.

1. A computer implemented method of determining score data for a location, the method comprising:
receiving a vote input by a user on a visit to a location from a user's mobile device, the vote input representing a vote for the location and including an identifier for the user's mobile device or the user and information identifying the location;
retrieving, from a computer storage device, score data for the user and score data for the location, the score data for the user being a derivative of previous vote inputs for locations and the score data for the location being a derivative of previous vote inputs by users for the location; and
determining, using a processor, score data for the visit dependent upon the score data for the user and the score data for the location;
wherein the score data for the location is modified dependent upon the determined score data for the visit.

2. A method according to claim 1, wherein the score data for the user is modified dependent upon the determined score data for the visit.

3. A method according to claim 1, including decaying the score data for the visit over time, wherein the score data for the location is modified dependent upon the decayed score data for the visit.

4. A method according to claim 2, including decaying the score data for the visit over time, wherein the score data for the location is modified dependent upon the decayed score data for the visit, and the score data for the user is modified dependent upon the decayed score data for the visit.

5. A method according to claim 1, including receiving a plurality of vote inputs by a plurality of users on a plurality of visits to the location, wherein the score data is determined for each visit dependent upon the score data for the user and the score data for the location, an order in which each visit occurs is recorded, the score data for each visit is modified dependent upon the order, and the score data for the location is modified dependent upon the determined score data for the visits.

6. A method according to claim 5, wherein the score data for each visit is modified by a factor dependent upon the inverse of the order.

7. A method according to claim 1, wherein the identifier for the user's mobile device or the user comprises a unique identifier for the user's mobile device.

8. A method according to claim 1, wherein the information identifying the location comprises location coordinates, location data on known locations is stored comprising location coordinates and descriptive information, and the method includes using the location coordinates to look up the stored location data.

9. A method according to claim 8, wherein if the location coordinates do not match location coordinate in the stored location data, the method including generating data on possible locations from the location data, outputting the data to the user's mobile device, receiving a user selection of a location, and using the user selected location to retrieve the score data for the location.

10. A method according to claim 8, wherein if the location coordinates do not match location coordinates in the stored location data, the method including outputting the a request for location information to the user's mobile device, receiving a user input location information, storing the user input information in the storage, and setting the score data for the location in the storage to an initial value.

11. A method according to claim 1, wherein the information identifying the location comprises geographic coordinates or geocode determined by the user's mobile device automatically.

12. A method according to claim 1, wherein the receiving, retrieving and determining are repeated for vote inputs by a plurality of users for visits to a plurality of locations, wherein the score data for each location is modified dependent upon the determined score data for the visits by the users to the location.

13. A method according to claim 12, wherein the score data for each user is modified dependent upon the determined score data for the visits to the locations by the user.

14. Computer apparatus for determining score data for a location, the apparatus comprising:
a program memory storing program code; and
a processor for implementing the program code stored in the program memory;
wherein the program code comprises:
code for controlling the processor to receive a vote input by a user on a visit to a location from a user's mobile device, the vote input representing a vote for the location and including an identifier for the user's mobile device or the user and information identifying the location;
code for controlling the processor to retrieve from storage score data for the user and score data for the location, the score data for the user being a derivative of previous vote inputs for locations and the score data for the location being a derivative of previous vote inputs by users for the location; and
code for controlling the processor to determine score data for the visit dependent upon the score data for the user and the score data for the location;
wherein the code for controlling the processor comprises code for controlling the processor to modify the score data for the location dependent upon the determined score data for the visit.

15. Computer apparatus according to claim 14, wherein the code for controlling the processor comprises code for controlling the processor to modify the score data for the user dependent upon the determined score data for the visit.

16. Computer apparatus according to claim 14, including the code for controlling the processor to decay the score data for the visit over time, wherein the code for controlling the processor comprises code for controlling the processor to modify the score data for the location dependent upon the decayed score data for the visit.

17. Computer apparatus according to claim 16, including code for controlling the processor to decay the score data for the visit over time, wherein the code for controlling the processor comprises code for controlling the processor to modify the score data for the location dependent upon the decayed score data for the visit, and the code for controlling the processor comprises code for controlling the processor to modify the score data for the user dependent upon the decayed score data for the visit.

18. Computer apparatus according to claim 14, including code for controlling the processor to receive a plurality of vote inputs by a plurality of users on a plurality of visits to the location, wherein the code for controlling the processor comprises code for controlling the processor to determine the score data for each visit dependent upon the score data for the user and the score data for the location, the code for controlling the processor comprises code for controlling the processor to record an order in which each visit occurs, the code for controlling the processor comprises code for controlling the processor to modify the score data for each visit dependent upon the order, and the code for controlling the processor comprises code for controlling the processor to modify the score data for the location dependent upon the determined score data for the visits.

19. Computer apparatus according to claim 14, wherein the information identifying the location comprises location coordinates, the code for controlling the processor comprises code for controlling the processor to store location data on known locations comprising location coordinates and descriptive information, and the code for controlling the processor comprises code for controlling the processor to use the location coordinates to look up the stored location data.

20. Computer apparatus according to claim 19, wherein the code for controlling the processor comprises code for controlling the processor to, if the location coordinates do not match location coordinate in the stored location data, generate data on possible locations from the location data, output the data to the user's mobile device, receive a user selection of a location, and use the user selected location to retrieve the score data for the location.

21. Computer apparatus according to claim 20, wherein the code for controlling the processor comprises code for controlling the processor to, if the location coordinates do not match location coordinate in the stored location data, output the a request for location information to the user's mobile device, receive a user input location information, store the user input information in the storage, and set the score data for the location in the storage to an initial value.

22. Computer apparatus according to claim 14, wherein the code for controlling the processor comprises code for controlling the processor to repeat the receiving, retrieving and determining for vote inputs by a plurality of users for visits to a plurality of locations, and the code for controlling the processor comprises code for controlling the processor to modify the score data for each location dependent upon the determined score data for the visits by the users to the location.

23. Computer apparatus according to claim 22, wherein the code for controlling the processor comprises code for controlling the processor to modify the score data for each user dependent upon the determined score data for the visits to the locations by the user.

24. A computer implemented method of processing vote inputs for a location, the method comprising:
receiving a vote input by a user on a visit to a location from a user's mobile device, the vote input representing a vote for the location and including an identifier for the user's mobile device or the user and information identifying the location; and
determining, using a processor, score data for the user, score data for the location, and score data for the visit by the user to the location using a graph processing method accessing a graph database storing the score data for the user, score data for the location, and score data for visits by users to the location;
the graph processing method dynamically calculating:
score data for the visit dependent upon the stored score data for the user and the stored score data for the location,
updated score data for the user using stored score data for the user and calculated score data for the visit, and
updated score data for the location using stored score data for the location and calculated score data for the visit.

25. A method according to claim 24, wherein vote inputs from a plurality of users for a plurality of locations are received; score data for the users, score data for the locations, and score data for the visits by the users to the locations are dynamically determined using the graph processing method accessing the graph database storing the score data for the users, score data for the locations, and score data for visits by users to the locations; and the graph processing method dynamically calculates:
score data for the visits dependent upon the stored score data for the respective users and the stored score data for the respective locations,
updated score data for the users using stored score data for the respective users and calculated score data for the respective visits, and
updated score data for the locations using stored score data for the respective locations and calculated score data for the respective visits.

26. Computer apparatus for processing vote inputs for a location, the apparatus comprising:
a graph database storing score data for users, score data for locations, and score data for visits by users to the locations;
a network interface for receiving a vote input by a user on a visit to a location from a user's mobile device, the vote input representing a vote for the location and including an identifier for the user's mobile device or the user and information identifying the location; and
a graph processor for determining score data for the user, score data for the location, and score data for the visit by the user to the location using a graph processing method accessing the graph database;
the graph processor being programmed to dynamically calculate:
score data for the visit dependent upon the stored score data for the user and the stored score data for the location,
updated score data for the user using stored score data for the user and calculated score data for the visit, and
updated score data for the location using stored score data for the location and calculated score data for the visit.

27. Computer apparatus according to claim 26, wherein the network interface is arranged to receive vote inputs from a plurality of users for a plurality of locations; and the graph processor is programmed to dynamically determine score data for the users, score data for the locations, and score data for the visits by the users to the locations by calculating:
score data for the visits dependent upon the stored score data for the respective users and the stored score data for the respective locations,
updated score data for the users using stored score data for the respective users and calculated score data for the respective visits, and
updated score data for the locations using stored score data for the respective locations and calculated score data for the respective visits.

28. A mobile device for use by a user to enter a vote for a location, the device comprising:
a location detector for detecting the location of the user;
a network interface for communicating the location over a network and for receiving map data;
a display to display a map of a region including the location of the user and an indication of the location of the user using the map data; and
a user input device to receive a user selection to vote for the location;
wherein the network interface is adapted to transmit an indication of the vote, and information identifying the location and the user.

29. A mobile device according to claim 28, wherein the network interface is adapted to receive map data including score data derived from votes from users for locations in the region, and the display is adapted to display the map with indicators indicative of the score data for the locations at the locations.

30. A method of entering a user vote for a location, the method comprising:
detecting the location of the user;
communicating the location over a network and receiving map data;
displaying a map of a region including the location of the user and an indication of the location of the user using the map data;
receiving a user selection to vote for the location; and
transmitting an indication of the vote and information identifying the location and the user.

31. A method according to claim 30, wherein the map data includes score data derived from votes from users for locations in the region, and the map is displayed with indicators indicative of the score data for the locations at the locations.
